(19) United States
(12) Patent Application Publication
(10) Pub. No.: US 2013/0176246 A1
(43) Pub. Date: Jul. 11, 2013

(54) INFORMATION PROCESSOR

(71) Applicant: Fujitsu Ten Limited, Kobe-shi (JP)

(72) Inventors: Nobuyuki KOHIGASHI, Kobe-shi (JP); Takehiro WAKAMATSU, Kobe-shi (JP)

(73) Assignee: FUJITSU TEN LIMITED, Kobe-shi (JP)

(21) Appl. No.: 13/692,230

(22) Filed: Dec. 3, 2012

(30) Foreign Application Priority Data
Jan. 10, 2012 (JP) 2012-002114

(51) Int. Cl. G06F 3/041

(52) U.S. Cl. CPC G06F 3/041
USPC 345/173

(57) ABSTRACT

An information processor includes a display that has a touch panel and that displays an image, and a controller that displays on the display the image that has an operation-part display area displaying at least a part of a plurality of operation buttons that receive instructions for executing prescribed functions, the instructions given by a touch operation. The operation-part display area has a switch operation area, a variable area and a fixed area. The variable area displays a part of the plurality of operation buttons, and changes over the part of the plurality of operation buttons to be displayed in response to the touch operation made on a page switch button shown in the switch operation area. The fixed area displays a part of a rest of the plurality of operation buttons fixedly regardless of the touch operation made on the page switch button.

### BACKGROUND OF THE INVENTION

1. Field of the Invention

The invention relates to a technology that displays a plurality of operation parts.

2. Description of the Background Art

There is a technology that generates a display image to be displayed on a touch panel so as to display the screen of the touch panel defined as a plurality of display areas, including the first display area that displays a navigation screen combined with navigation operation buttons, and the second display area that displays prescribed operation buttons having the functions except for navigation functions (Japanese Patent Application Laid-open Publication No. 2010-066197). There is another technology that draws the display screen including operation button display area that displays one or more operation buttons associated with each screen (Japanese Patent Application Laid-open Publication No. 2010-173374). Moreover, there is another technology that moves the area displaying application icons based on vertical scrolling or horizontal scrolling (Japanese Patent Application Laid-open Publication No. 2010-034140).

Basically during driving on a vehicle such as a car, a user can hardly concentrate on watching the operation screen on an in-vehicle apparatus such as a navigation apparatus. Therefore, the in-vehicle apparatus is desired to have good operability.

These days, the functions included in the in-vehicle apparatus are increasing. Thus, the operation buttons that receive the instructions for executing respective functions included in the in-vehicle apparatus are increasing. The operation buttons may be configured as mechanical hardware buttons or software buttons that are displayed in the operation screen of the in-vehicle apparatus and that are executed by software.

If many of such operation buttons are disposed, each of the operation buttons is naturally displayed in a small size. That is, disposing many operation buttons results in declining the operability of the in-vehicle apparatus. Such a problem is especially seen in the case of the in-vehicle apparatus that is designed in a limited size. However, such a problem is also seen even in the case of an information processor other than the in-vehicle apparatus, such as a smart phone.

### SUMMARY OF THE INVENTION

According to one aspect of the invention, an information processor includes a display that has a touch panel and that displays an image, and a controller that displays on the display the image that has an operation-part display area displaying at least a part of a plurality of operation parts that receive instructions for executing prescribed functions, the instructions given by a touch operation of the operation parts by a user. The operation-part display area has a first area that displays a switch operation part that receives an instruction for executing a function to change over contents displayed in the operation-part display area, the instruction given by a touch operation of the switch operation part by the user, a second area that displays a part of the plurality of operation parts and that changes over the part of the plurality of operation parts to be displayed in the second area in response to the touch operation made by the user on the switch operation part, and a third area that displays a part of a rest of the plurality of operation parts fixedly regardless of the touch operation made by the user on the switch operation part. Each of the plurality of operation parts is able to be selected for display in either of the second and third areas, and assigned to be displayed in one of the second and third areas.

On the information processor, each of a plurality of operation buttons is assigned to be displayed in the second area or the third area in accordance with importance of each of the functions of the operation buttons. Therefore, by assigning the operation buttons that receive the instructions for executing the more important functions in the third area, the operation buttons corresponding to the more important functions can be displayed continuously.

According to another aspect of the invention, the controller displays the first area between the second area and the third area.

The disposition helps to show the apparent boundary between the second area and the third area. The disposition also helps to reduce the movement amount of user's eyes or finger during operation.

Therefore, the object of the invention is to improve the operability of the information processor.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 exemplarily shows a screen displayed on a display of an in-vehicle apparatus.

FIG. 2 exemplarily shows another screen displayed on the display of the in-vehicle apparatus.

FIG. 3 exemplarily shows another screen displayed on the display of the in-vehicle apparatus.

FIG. 4 exemplarily shows a configuration of the in-vehicle apparatus.

FIG. 5 exemplarily shows transition of the screens to be displayed on the display of the in-vehicle apparatus.

FIG. 6 exemplarily shows a functional configuration of the processing for display or others on the in-vehicle apparatus.

FIG. 7 is a flowchart showing an example of processing for button operation on the in-vehicle apparatus.

FIG. 8 is a flowchart showing an example of processing for button assignment on the in-vehicle apparatus.

### DESCRIPTION OF THE EMBODIMENTS

Hereinafter, an embodiment of one aspect of the invention is described with reference to accompanying drawings. The embodiment described hereafter is just the example of the invention in all respects. The invention is not limited by the embodiment. It is therefore understood that numerous other modifications and variations can be devised without departing from the scope of the invention. That is, the invention may be realized by appropriate adoption of specific configurations in conformity with the embodiment.

The data used in the embodiment are described by a natural language. However, the data are specified in particular by a computer-readable pseudo language, commands, parameters, a machine language, or the like.

Further, described here in the embodiment is, as one example of an information processor, the in-vehicle apparatus that is installed in a vehicle such as a car, and that includes a navigation function and an audio function. However, application of the technology described hereafter is not limited to such an in-vehicle apparatus. The technology described hereafter may be applied to an information processor other than the in-vehicle apparatus, such as a smart phone. The functions included in the information processor such as an in-vehicle apparatus may be selected appropriately.

<1. In-Vehicle Apparatus>

<1-1. Outline of Screen>

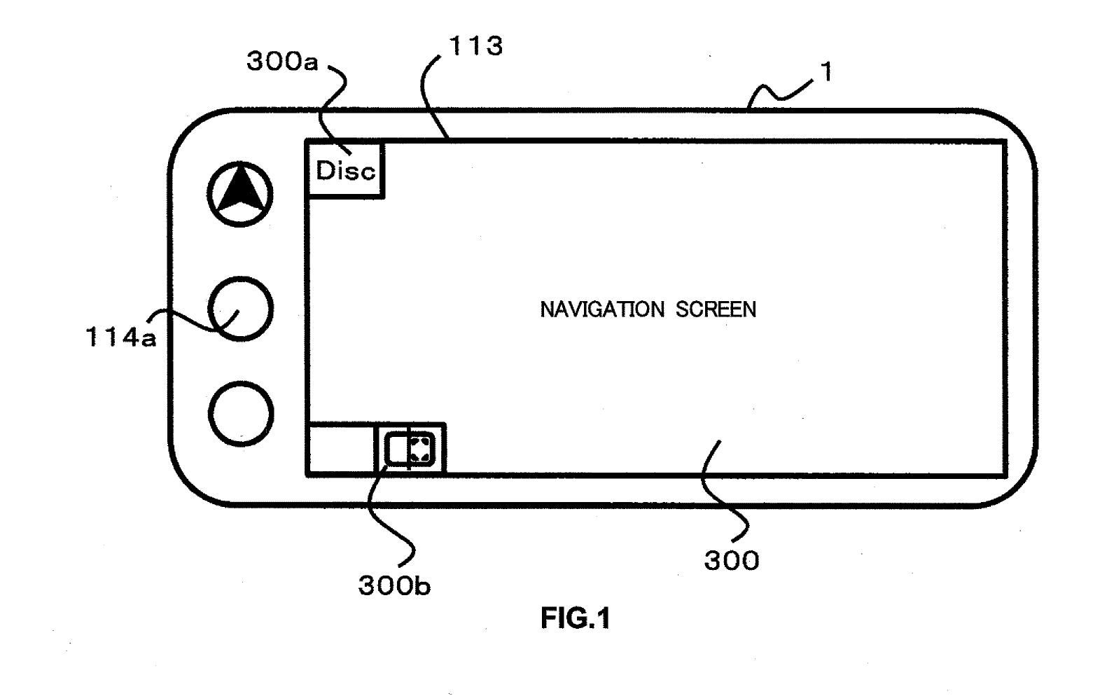

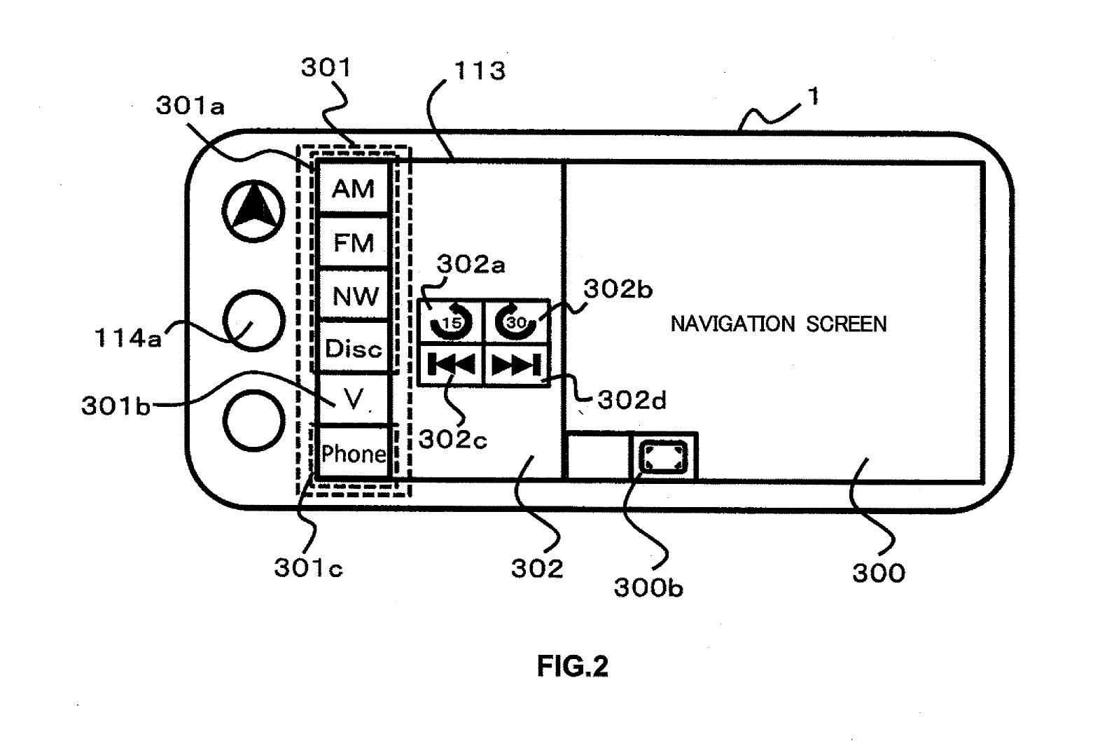

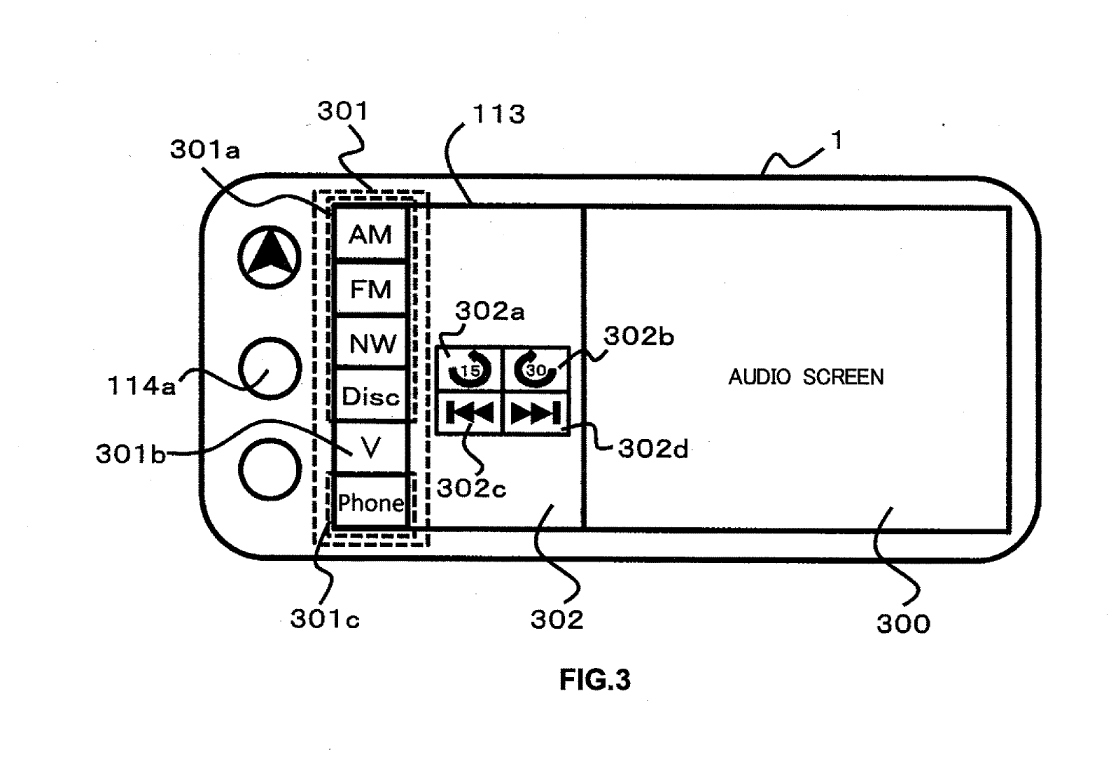

Each of FIG. 1, FIG. 2 and FIG. 3 exemplarily shows the screen displayed on a display 113 of an in-vehicle apparatus 1 of the embodiment. The image displayed on the display 113 includes an operation area 300. The operation area 300 displays the operation screen for a navigation function or an audio function. In an example, when the program for the navigation function is run on the in-vehicle apparatus 1, the operation area 300 displays the route guide information including a map image and the cursor showing the current position of the vehicle, as the operation screen for the navigation function. FIG. 1 displays the operation area 300 that displays the operation screen for the navigation function and that covers substantially all the area of the image displayed on the display 113.

The in-vehicle apparatus 1 includes a function switch button 114a as an operation part 114 described later. A switch part such as a microswitch (push-type switch part) is installed under a surface panel sheet of the part of the function switch button 114a that is a mechanically-installed hardware button.

The function switch button 114a is a push button switch that receives an instruction for changing over between the operation screen for the navigation function and the operation screen for the audio function. When the function switch button 114a is operated (pushed) at the state where the operation screen for the navigation function is displayed, the operation screen displayed in the operation area 300 is changed over to the operation screen for the audio function. When the function switch button 114a is operated at the state where the operation screen for the audio function is displayed, the operation screen displayed in the operation area 300 is changed over to the operation screen for the navigation function.

At the state displaying the operation screen for the navigation function full-screen, the operation area 300 displays a source change button 300a and a screen-split switch button 300b as well, as shown in FIG. 1. The source change button 300a and the screen-split switch button 300b are the operation parts that are executed by software. That is, the source change button 300a and the screen-split switch button 300b are the software buttons that are executed by the processing of a controller, and that receive the instruction for executing the function corresponding to the operated position on the touch panel installed in the display 113. As above, the operation part may be displayed in the area other than an operation-part display area 301 described later.

The source change button 300a displayed in the operation area 300 shown in FIG. 1 shows the audio source selected for reproduction on the program of audio function at the time. When the source change button 300a at this state is operated, the display 113 displays the screen shown in FIG. 3 described later in order to change the audio source for reproduction.

The screen-split switch button 300b is the operation part that receives the instruction for changing over the operation screen for the navigation function between full-screen display and split-screen display. When the screen-split switch button 300b is operated on the screen shown in FIG. 1, the screen of the display 113 is changed over to the screen shown in FIG. 2.

FIG. 2 exemplarily shows an operation screen for the navigation function in the split state. The image displayed in this state on the display 113 includes the operation-part display area 301 and a source operation area 302, besides the operation area 300 displaying the operation screen for the navigation function. The operation-part display area 301 displays a plurality of operation parts (hereinafter, may be indicated as “operation button(s)”), each of which receives the instruction (instruction given by touch operation on the display 113 including a touch panel function) for executing a prescribed function. The plurality of operation buttons displayed in the operation-part display area 301 are the operation parts that are executed by the touch panel function. That is, the plurality of operation buttons are the software buttons that are executed by software based on the processing of the controller, each of which receive the instruction for executing the function corresponding to the operated (pushed) position on the touch panel. The source operation area 302 displays the operation screen corresponding to the audio source selected for reproduction on the program of audio function at the time.

Described here in the embodiment is, as an example of the operation button displayed in the operation-part display area 301, the operation button that receives the instruction for selecting one audio source for reproduction among a plurality of audio sources. However, the types of the operation buttons to be displayed in the operation-part display area 301 are not limited to the type of the operation button that receives the instruction for selecting the audio sources (hereinafter, referred to as “source selector button”). In another embodiment, the type of the operation button to be displayed in the operation-part display area 301 may be appropriately selected.

The operation-part display area 301 includes a variable area 301a, a fixed area 301c and a switch operation area 301b. The variable area 301a displays the operation buttons variably. The fixed area 301c displays the operation buttons fixedly. The switch operation area 301b displays the operation button (hereinafter, referred to as “page switch button”) that receives the instruction for executing the function for changing over the operation buttons displayed in the variable area 301a to other operation buttons (operation buttons for the functions other than the functions of the currently displayed operation buttons). The page switch button corresponds to the switch operation part that receives the instruction (instruction given by the touch operation) for executing the function for changing over the contents displayed in the operation-part display area 301.

Moreover, the variable area 301a, the switch operation area 301b and the fixed area 301c are disposed along a vertical line at the edge (left edge in the embodiment) of the screen on the display 113. That is, the plurality of operation buttons included in these three areas of 301a, 301b and 301c are disposed in one line. This screen composition provides the easy-to-find location of each of the plurality of operation buttons, and also provides effective display of images such as a map.

The in-vehicle apparatus 1 prepares the plurality of operation buttons corresponding to the functions available on the in-vehicle apparatus 1, as the operation buttons that the operation-part display area 301 can display. In an example, when the operation button corresponds to the source selector button, the in-vehicle apparatus 1 prepares the plurality of operation buttons, each of which corresponds to one of the plurality of audio sources reproducible on the in-vehicle apparatus 1. The plurality of operation buttons can be selected for display in either of the variable area 301a and the fixed area 301c. Each of the plurality of operation buttons is assigned to be displayed in one of the variable area 301a and the fixed area 301c of the operation-part display area 301. The operation-part display area 301 displays all or a part of the plurality of prepared operation buttons.

The variable area 301a variably displays a part of the plurality of prepared operation buttons. That is, the variable area 301a changes over the operation buttons for display in response to the touch operation made on the page switch button. The variable area 301a shown in FIG. 2 displays the source selector button that receives the instruction for selecting AM broadcasting (“AM” button in FIG. 2), the source selector button that receives the instruction for selecting FM broadcasting (“FM” button in FIG. 2), the source selector button that receives the instruction for selecting network radio broadcasting (“NW” button in FIG. 2) and the source selector button that receives the instruction for selecting a disc medium such as a CD (Compact Disc) (“Disc” button in FIG. 2). When a user makes touch operation on the page switch button at the state shown in FIG. 2, the source selector buttons displayed in the variable area 301a are changed over to the source selector buttons for the audio sources different from the displayed source selector buttons.

Moreover, the in-vehicle apparatus 1 is capable of accepting the instruction made by a user for rearrangement of the operation buttons to be displayed in the variable area 301a. In an example, the positions of the operation buttons to be displayed in the variable area 301a can be rearranged so that the operation buttons are disposed preferentially in order of importance levels. Hereinafter, the entire image (all of the plurality of operation buttons) displayed at a time in the variable area 301a is referred to as a “page.” For rearrangement of the operation buttons to be displayed in the variable area 301a, it is desirable that highly-important operation buttons be assigned to be displayed on the preceding pages. For rearrangement of the operation buttons, in an example, a user drags the operation button targeted for position change to a preferable position. During dragging the operation button, when the position of the target operation button reaches to the top edge or the bottom edge of the variable area 301a, the variable area 301a displays an adjacent page. Through the processing, the user can move the target operation button to the preferable position on the appropriate page.

The fixed area 301c fixedly displays a part of the rest of the operation buttons prepared in advance. Even when the user makes touch operation on the page switch button, the operation buttons displayed in the fixed area 301c are not changed over. That is, the fixed area 301c continues to display the same operation buttons, regardless of the touch operation made on the page switch button. Thus, it is desirable that the fixed area 301c display the operation buttons for the functions having specially-important functions among the available functions on the in-vehicle apparatus 1. The fixed area 301c shown in FIG. 2 displays the source selector button (“Phone” button in FIG. 2) that receives the instruction for executing a hands-free call through the mobile phone connected with the in-vehicle apparatus 1, and for selecting the voice during the call as the audio source.

The in-vehicle apparatus 1 is also capable of accepting, from a user, assignment of the operation button to be displayed in the fixed area 301c. The user can voluntarily select the operation button to be displayed fixedly in the operation-part display area 301 regardless of the operation made on the page switch button, among the plurality of operation buttons prepared in advance. Therefore, the user can set the operation button such as “AM” button or “FM” button displayed in the variable area 301a shown in FIG. 2, as the operation button in the fixed area 301c. On the contrary, the user can set “Phone” button displayed in the fixed area 301c shown in FIG. 2, as the operation button in the variable area 301a. The user disposes in the fixed area 301c the operation button for the function that is needed in an urgent situation or that is frequently executed due to its importance.

The switch operation area 301b displays the page switch button that receives the instruction for changing over the operation buttons to be displayed in the variable area 301a. The page switch button shown in FIG. 2 displays the button that shows a downward arrow, and that corresponds to a so-called page-down button. The page switch button corresponding to a so-called page-up button shows an upward arrow (not shown in FIG. 2). In the embodiment, when the user operates the page switch button corresponding to the page-down button, the variable area 301a displays the next page. When the user operates the page switch button corresponding to the page-up button, the variable area 301a displays the previous page.

When the user operates the page switch button repeatedly, the variable area 301a may display the pages sequentially in a cycle. That is, every time the user operates the page switch button, the variable area 301a changes the page to be displayed in turn among the plurality of pages. When the user operates the page switch button on the last page, the variable area 301a may be back to the first page to be displayed. In this case, the indication where the currently-displayed page (page number) is, for example, indication of “⅔” (currently-displayed page/number of total pages), provides convenience to the user.

It is desirable that the switch operation area 301b be disposed between the variable area 301a and the fixed area 301c as in the embodiment. Disposing the switch operation area 301b at the above-described position helps to show the apparent border between the area where the operation buttons are changed over (variable area 301a) based on the pushing on the page switch button and the area where the operation buttons are displayed fixedly (fixed area 301c). The disposition described above also helps to reduce the movement amount of user's eyes or finger during operation. That is, disposing the switch operation area 301b at the above-described position improves the operability of the operation buttons displayed in the operation-part display area 301.

When the user operates the screen-split switch button 300b on the screen shown in FIG. 2, the screen of the display 113 is back to the screen shown in FIG. 1.

It is desirable that the user can change at will the number of the operation buttons to be displayed in the variable area 301a and the number of the operation buttons to be displayed in the fixed area 301c, or the area sizes of the areas 301a, 301b and 301c. In the example shown in FIG. 2, the fixed area 301c displays one operation button. However, the fixed area 301c may display two operation buttons in the same size (that is, the fixed area 301c is expanded to approximately twice the original area size). In another example, a user may be able to change the number of the operation buttons for display in the fixed area 301c within the number determined in advance.

The source operation area 302 displays the operation screen corresponding to the audio source selected for reproduction through the operation, for example, made on the source selector button shown in the operation-part display area 301. FIG. 2 shows the sample case where the selected audio source has constant-length contents for reproduction such as a music file or a video file. In such a case, the source operation area 302 displays an operation button 302a, an operation button 302b, an operation button 302c and an operation button 302d, each of which receives the instruction for operating the contents during being reproduced.

The source operation area 302 may display the operation button that receives the instruction for reversing or forwarding the reproduction of the contents for a predetermined time. The operation button 302a receives the instruction for reversing the reproduction of the contents for 15 seconds. The operation button 302b receives the instruction for forwarding the reproduction of the contents for 30 seconds. The in-vehicle apparatus 1 may accept the instruction for changing such setting of the predetermined time for reverse operation or the forwarding operation (the period of time for reversing or forwarding per operation) of the reproduction of the contents.

FIG. 3 shows the example of the operation area 300 that displays the operation screen for the audio function. When the function switch button 114a is operated at the state shown in FIG. 1 or FIG. 2, the display 113 changes the screen to the state shown in FIG. 3. When the function switch button 114a is once again operated at the state shown in FIG. 3, the display 113 changes the screen back to the state shown in FIG. 1 or FIG. 2. The operation screen for the audio function displays the operation button for the operation common in various audio sources, for example, a volume controller.

The in-vehicle apparatus 1 is capable of changing over the operation buttons displayed in the variable area 301a in response to the touch operation made on the page switch button, which can reduce the number of the operation buttons to be displayed on the screen of the display 113. Moreover, disposing the switch operation area 301b between the variable area 301a and the fixed area 301c helps to show the apparent border between the area where the operation buttons are displayed variably and the area where the operation buttons are displayed fixedly. Owing to these advantages, the in-vehicle apparatus 1 provides the interface having advanced operability.

In the embodiment, “operation made on an operation button” is, for example, that a user touches the area displaying an icon of one of the various operation buttons by user's finger or others.

The in-vehicle apparatus 1 shown as an example in FIG. 1, FIG. 2 or FIG. 3 is designed on the assumption of installation on a left-hand drive vehicle. Therefore, the operation-part display area 301 including the variable area 301a, the switch operation area 301b and the fixed area 301c is disposed at the left edge of the display 113 that is the near side from a driver seat on the vehicle. In the case of the in-vehicle apparatus 1 designed on the assumption of installation on a right-hand drive vehicle, it is desirable that the operation-part display area 301 be disposed at the right edge of the display 113 that is the near side from a driver seat on the vehicle. As above, the operation-part display area 301 may be disposed appropriately according to a use situation.

<1-2. Configuration Example of in-Vehicle Apparatus>

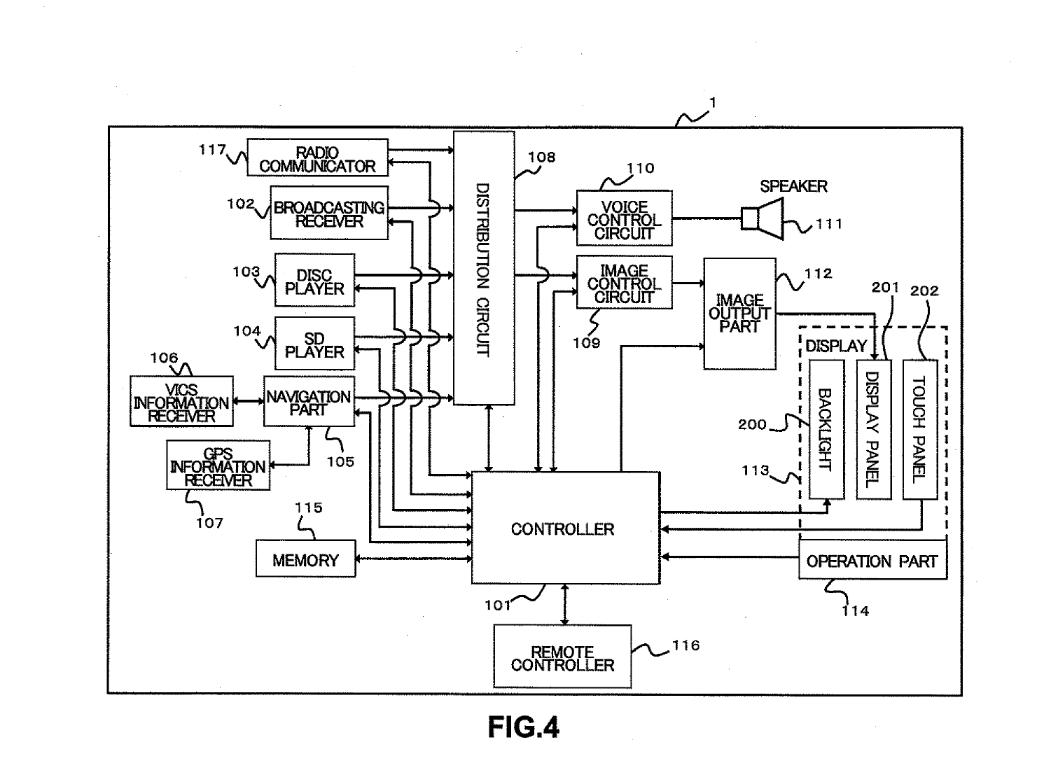

FIG. 4 shows a configuration example of the in-vehicle apparatus of the embodiment. The in-vehicle apparatus 1 is described with reference to FIG. 4 exemplarily based on the in-vehicle all-in-one apparatus including audio, visual and navigation functions.

A controller 101 receives the signal transmitted by the each part of the in-vehicle apparatus 1 or by a connected external device, or receives the operation instruction signal transmitted by each of the operation parts based on user's operation. Based on such a signal, the controller 101 totally controls the each part of the in-vehicle apparatus 1 or the external device. The controller 101 includes, for example, one or more microcomputers and peripheral circuits [ROM (Read Only Memory), RAM (Random Access Memory), interface circuit, etc.] to be used in the processing of the microcomputer. The controller 101 works in accordance with the programs stored in the peripheral circuits such as ROM.

A broadcasting receiver 102 selectively receives broadcasting waves having specific frequency received through an antenna, and transfers the demodulated audio signals and image signals (in the case of television broadcasting) of the broadcasting wave to a distribution circuit 108. The broadcasting receiver 102 is composed of a tuning circuit, a demodulating circuit, a decoder circuit, etc. The broadcasting receiver 102 is controlled based on the control signal transmitted by the controller 101 in terms of the various behaviors such as on/off operation and reception frequency.

A disc player 103 reads the data stored in a disc medium [e.g. CD, DVD (Digital Versatile Disc), BD (Blue-ray Disc)] by a pickup, and transfers to the distribution circuit 108 the audio signals, the video signals and other signals obtained based on the read data. The disc player 103 includes an optical pickup, a pickup/disc driver, a control circuit for the pickup/disc driver and a decoder circuit for the read signals. The disc player 103 is controlled based on the control signal transmitted by the controller 101, in terms of the various behaviors such as the on/off control of the processing for reading, and the control of a reading location.

An SD player 104 includes a connector to connect an SD card. The SD player 104 reads out the data from the various data stored in the SD card connected with the connector, and transfers the read-out image signal, an audio signal, a character signal or other signals to the distribution circuit 108. The SD player 104 is controlled based on the control signal transmitted by the controller 101, in terms of the various behaviors such as the on/off control of the processing for reading out data from the SD card connected with the connector, and the selection of reading-out data.

A navigation part 105, for providing route guidance to a destination, displays the current vehicle position or the route to the destination on a map, guides a traveling direction such as of right/left turn at an intersection or other points by voice or other methods, and displays the traffic information obtained from a VICS information receiver 106 described later and the information of the current vehicle position obtained from a GPS information receiver 107 described later as well. The navigation part 105 includes a memory (medium) that stores the map information to be used for navigation, a CPU (Central Processing Unit) that executes various types of arithmetic processing, and another memory such as a RAM that stores the data to be used for various types of processing. The navigation part 105 is controlled based on the control signal transmitted by the controller 101 in terms of various behaviors such as the on/off control of processing for navigation. The memory (medium) that stores the map information to be used for navigation may be the previously-described SD card that is connected with the SD player 104, or the previously-described disc that is processed by the disc player 103.

The VICS information receiver 106 receives the traffic information of VICS (Vehicle Information and Communication System: registered trademark), and transmits the received traffic information to the navigation part 105. The VICS information receiver 106 includes a receiver (FM receiver, radio beacon receiver, optical beacon receiver) that receives data from VICS, and a decoder circuit that decodes the received data.

The GPS information receiver 107 detects the current vehicle position based on the GPS signals transmitted by GPS satellites, and transmits the detected information of the current vehicle position to the navigation part 105. The GPS information receiver 107 includes a GPS signal receiving circuit that receives the GPS signal, and the calculation part that calculates the current vehicle position based on the received GPS signals.

The distribution circuit 108 is controlled based on the control signal transmitted by the controller 101, and transmits the image signal and the audio signal transmitted by the source (broadcasting receiver 102, etc.) that is specified as an output source among the various sources, respectively to an image control circuit 109 and a voice control circuit 110. The distribution circuit 108 includes a switch group that includes an electronic circuit such as a relay or a switching transistor.

The image control circuit 109 is controlled based on the control signal transmitted by the controller 101, controls the luminance, the color tone, the contrast, etc. of the image signal transmitted by the distribution circuit 108, and transmits each of the controlled image signals to an image output part 112. The image control circuit 109 includes the memory that stores the image data, and an operation circuit such as a digital signal processor that executes arithmetic processing of the image data.

The voice control circuit 110 is controlled based on the control signal transmitted by the controller 101, controls the volume and the tone of the audio signals transmitted by the distribution circuit 108, and transmits the controlled audio signals to a speaker 111. The voice control circuit 110 includes the memory that stores the voice data, the operation circuit such as a digital signal processor that executes arithmetic processing of the voice data, and the amplifier/attenuation circuit or the resonance circuit that includes a transistor, a resistance, a capacitor or a coil. The speaker 111 outputs the audio signal transmitted by the voice control circuit 110.

The image output part 112 is controlled based on the control signal transmitted by the controller 101, performs processing such as image composition based on the image signal transmitted by the image control circuit 109 and the display image signal transmitted by the controller 101 to display the image signal on the display 113, and drives the display 113 based on the processed image signal. The image output part 112 includes, for example, the image ASIC that is the operation circuit specialized for image processing by arithmetic processing, the video memory that stores the image data for image processing and transmission, and the image drive circuit that drives the display 113 based on the image data stored in the video memory for image output.

The display 113 displays images based on the image signal transmitted by the image output part 112. The display 113 includes, for example, a display panel 201 such as a liquid-crystal display, an organic EL display, a plasma display or a cold-cathode flat panel display, a backlight 200 that lights the display panel 201 from the back, and a touch panel 202 that is operated by a resistive-membrane system or a capacitance system. The touch panel 202 transmits to the controller 101 the information of the various types of operation made by a user on the in-vehicle apparatus 1.

In the embodiment, the display 113 displays the various types of operation buttons. Each of these operation buttons (refer to FIG. 1, FIG. 2 and FIG. 3) displayed on the display 113 (display panel 201) is the operation part that receives the instruction (instruction given by the touch operation on the touch panel 202) for executing a prescribed function.

The operation part 114 is the input part where the user makes the various types of operation on the in-vehicle apparatus 1. The operation part 114 is a hardware switch such as a push switch, a rotary switch, or a joystick. The operation part 114 transmits to the controller 101 the conditions of the various types of the operation made by the user on the in-vehicle apparatus 1. As an example of the operation part 114, the function switch button 114a composed of the push button switch is used in the embodiment. The number and the types of the switches to be used as the operation part 114 are appropriately determined in accordance with the usage of the switch.

A memory 115 is the memory (memory medium) that stores various data and control programs, and includes, for example, a HDD (Hard Disk Drive) and a rewritable flash memory. The memory 115 is controlled based on the control signal transmitted by the controller 101, and transmits the desired data to a peripheral circuit such as the RAM included in the controller 101.

A remote controller 116 is installed at the place far away from the main body of the in-vehicle apparatus 1 installed in the instrument panel of the vehicle, for example, at the position near the armrest set between a driver seat and a passenger seat, or on a steering wheel, and transmits the conditions of the user's input operation. The remote controller 116 detects the rotation operation, the tilt operation and the push operation made on the operation part, in the embodiment. The remote controller 116 is composed of the rotary switch that transmits a signal based on the amount/direction of the rotation operation, the tilt sensor, such as of a joystick, that is composed of a pressure sensor and that transmits a signal based on the direction of the tilt operation, and the push button switch that changes an on/off state by the push operation.

A radio communicator 117 obtains data from the other devices such as a mobile phone, connected by radio communication of infrared communication or Bluetooth (registered trademark). Then, the radio communicator 117 transmits the audio signal, the image signal and other signals based on the received data to the distribution circuit 108. The radio communicator 117 is controlled based on the control signal transmitted by the controller 101 in terms of the various behaviors such as the on/off control of communication processing, and data acquisition.

The in-vehicle apparatus 1 may include a communication unit for connecting a network such as the Internet, in addition to the radio communicator 117. In this case, the in-vehicle apparatus 1 is capable of obtaining various information and functions (programs) through the network.

<2. Example of Operation>

<2-1. Screen Transition>

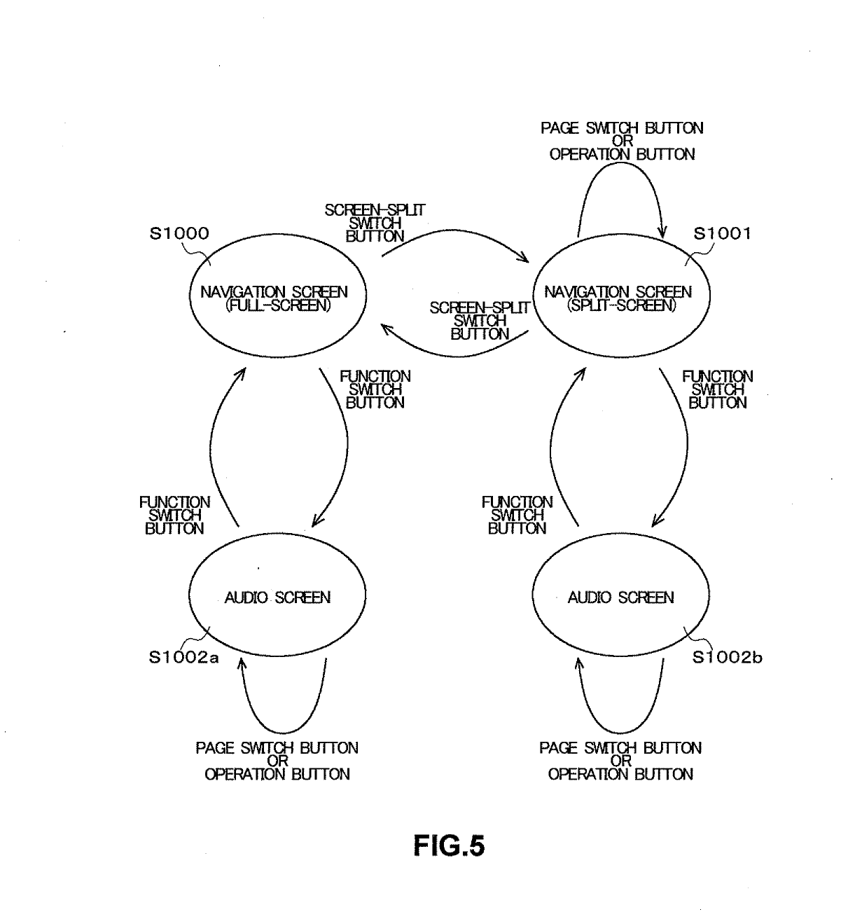

FIG. 5 exemplarily shows transition of the screens to be displayed on the display 113 of the in-vehicle apparatus 1 of the embodiment.

Upon execution of the program for the navigation function, the controller 101 displays the operation screen for the navigation function (execution screen for the program for the navigation function) on the display 113, as shown in FIG. 1 (S1000). In an example, the controller 101 displays a route guide screen on the display 113 as the operation screen for the navigation function. In this situation (S1000), the operation screen for the navigation function is displayed on the substantially entire screen of the display 113.

When the screen-split switch button 300b is operated at the state (S1000) where the operation screen for the navigation function is displayed on the substantially entire screen of the display 113, the controller 101 splits the screen of the display 113 as shown in FIG. 2, and displays the operation screen for the navigation function in the operation area 300 after split (S1001). In particular, the controller 101 displays on the display 113 the image including the operation area 300, the operation-part display area 301 and the source operation area 302.

When the function switch button 114a is operated at the state (S1000) where the operation screen for the navigation function is displayed on the substantially entire screen of the display 113, the controller 101 displays the operation screen for the audio function in the operation area 300 of the display 113, as shown in FIG. 3 (S1002a). When the function switch button 114a is again operated at the state (S1002a), the controller 101 puts the screen back to the original state (S1000) for display on the display 113.

When the function switch button 114a is operated at the state (S1001) where the operation screen for the navigation function is displayed in a divided area, the controller 101 displays the operation screen for the audio function on the display 113, as shown in FIG. 3 (S1002b). When the function switch button 114a is again operated at the state (S1002b), the controller 101 puts the screen back to the original state (S1001) for display on the display 113.

When the page switch button displayed in the switch operation area 301b is operated at the state (S1001) where the operation screen for the navigation function is displayed in the divided area, the controller 101 changes over the plurality of operation buttons (page) displayed in the variable area 301a, while keeping the state of the operation screen for the navigation function (S1001). In an example, when the page switch button corresponding to the page-down button is operated, the controller 101 turns the page displayed in the variable area 301a to the next. When the page switch button corresponding to the page-up button is operated, the controller 101 turns the page displayed in the variable area 301a back to the one before.

At the state (S1001) where the operation screen for the navigation function is displayed in the divided area, when one of the operation buttons displayed in the variable area 301a or the fixed area 301c is operated, the controller 101 executes the function corresponding to the operated operation button, while keeping the state of the operation screen for the navigation function (S1001). In an example, the controller 101 sets the audio source for reproduction corresponding to the operated operation button, as well as displaying the operation screen corresponding to the audio source in the source operation area 302.

The behaviors made by the page switch button and the operation buttons at the state (S1002a, S1002b) where the operation screen for the audio function is displayed in the operation area 300 are the same as the ones described above. Thus, description of the behaviors is omitted.

<2-2. Example of Processing>

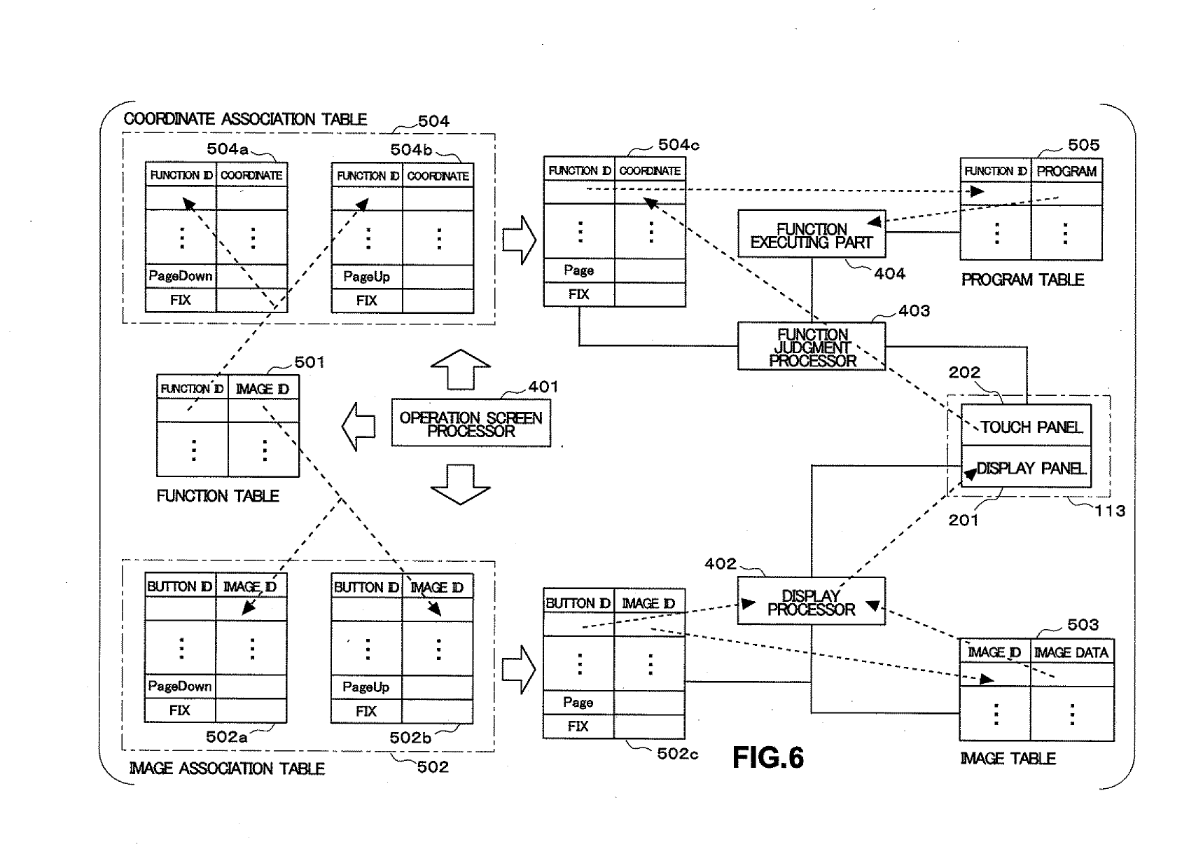

FIG. 6 exemplarily shows a functional configuration of the processing for displaying the operation button in the operation-part display area 301 on the in-vehicle apparatus 1 of the embodiment (including the processing for changing over the operation buttons displayed in the variable area 301a) and the processing for executing the operation made on the operation button. Each of the arrows (dotted arrows) shown in FIG. 6 exemplarily shows flow of reference data and of the processing controlled by the controller 101.

The in-vehicle apparatus 1 includes, as shown in FIG. 6, an operation screen processor 401, a display processor 402, a function judgment processor 403 and a function executing part 404, in order to execute the processing for displaying the operation buttons or other types of processing. Each processing of the operation screen processor 401, the display processor 402, the function judgment processor 403 and the function executing part 404 is performed, for example, when the program or others stored in the disc to be played by the disc player 103, the SD card connected with the SD player 104 or the memory 115 is delivered to the RAM or others that is the peripheral circuit of the controller 101, and is executed by the processor of the controller 101.

As shown in FIG. 6, the in-vehicle apparatus 1 refers to a function table 501, an image association table 502, an image table 503, a coordinate association table 504 and a program table 505, in order to execute the processing for displaying the operation buttons or other types of processing. Each of the function table 501, the image association table 502, the image table 503, the coordinate association table 504 and the program table 505 is stored in, for example, the disc to be played by the disc player 103, the SD card connected with the SD player 104 or the memory 115, and is delivered to the RAM or others that is the peripheral circuit of the controller 101, in accordance with necessity.

<2-2-1. Display of Operation Button>

Described is the processing for displaying the operation buttons in the operation-part display area 301. The controller 101 refers to the image association table 502 and the image table 503, in order to display the operation buttons in the operation-part display area 301.

The image association table 502 is the data to associate the operation buttons to be displayed in the operation-part display area 301 with images, and shows the association between a button ID and an image ID. The button ID is the information for specifying the operation button to be displayed in the operation-part display area 301. In the embodiment, the position of the operation button is specified by the position stored in the table, and the type of the operation button is specified by the button ID. The image ID is the information for specifying the image of the operation button that receives the instruction for selecting the associated audio source.

The image association table 502 is provided for each page to be displayed in the variable area 301a. An image association table 502a, for example, is the data to be used when the top page is selected as the page to be displayed in the variable area 301a. An image association table 502b is the data to be used when the last page is selected as the page to be displayed in the variable area 301a. That is, the image association table 502 is a group of the data set showing the association among the position, the type and the image type of the operation buttons, and one of the image association tables 502 (table 502a, table 502b in the embodiment) is provided for each page (the group of a plurality of operation buttons to be displayed at a time in the variable area 301a) being changed over by the page switch button.

The image table 503 is the data to associate the image ID specified by the image association table 502 with the image data to be used for drawing the image of the operation button. An image data field may store the image data themselves or the data that specify the location where the image data specified by the image ID are stored.

The controller 101 selects one of the image association tables 502, which corresponds to the page to be displayed at the time, as the processing of the operation screen processor 401. The target image association table selected by the controller 101 at the time is treated as a target image association table 502c shown in FIG. 6. The controller 101 draws the operation button in the operation-part display area 301 by use of the target image association table 502c as the processing of the operation screen processor 401.

When the page switch button corresponding to the page-down button is operated, the controller 101 selects the image association table (table 502b in the embodiment) that is the page next to the currently-displayed page, and updates the target image association table 502c. When the page switch button corresponding to the page-up button is operated, the controller 101 selects the image association table (table 502a in the embodiment) that is the preceding page of the currently-displayed page, and updates the target image association table 502c. Through the processing described above, the controller 101 is capable of changing over the operation buttons to be displayed in the variable area 301a.

Each of the image association tables 502 includes not only the operation buttons to be displayed in the variable area 301a, but also the data corresponding to the operation buttons to be displayed in either of the switch operation area 301b and the fixed area 301c.

The data of the record in “PageDown” or “PageUp” shown in FIG. 6 are the data corresponding to the page switch button that is the operation button to be displayed in the switch operation area 301b. The data of the record in “FIX” shown in FIG. 6 are the data corresponding to the operation button to be displayed in the fixed area 301c. The data of the records other than these records are the data corresponding to the operation buttons to be displayed in the variable area 301a.

However, the operation button displayed in the fixed area 301c is not changed by the operation made on the page switch button. Thus, the data of the record corresponding to the operation button displayed in the fixed area 301e are common in all of a plurality of image association tables 502. That is, in all of the image association tables 502, the data (button ID, image ID) corresponding to the operation button to be displayed in the fixed area 301c are the same. Moreover, the data corresponding to the operation button to be displayed in the switch operation area 301b shows the direction from the currently-displayed page to the existing next page.

These are the same as in the coordinate association table 504 described later.

After selecting the image association table 502 to be used for drawing the operation button (after updating the target image association table 502c), the controller 101 specifies the image data to be used for drawing the operation button based on the image table 503, as the processing of the display processor 402. Then, the controller 101 draws the operation button on the display panel 201 by use of the specified image data.

In particular, the controller 101 specifies by referring to the image table 503 the record of the image ID corresponding to the image ID of the target image association table 502c. The controller 101 is capable of associating the operation button specified by the button ID with the image data of the operation button based on the data stored in the image data field of the specified record. Thus, the controller 101 draws the image of the operation button shown in the image data at the position of the operation button specified by the button ID on the display panel 201 by use of the button ID and the image data that are associated. The display position of each of the image data is associated with the order of the corresponding record in the target image association table 502c.

In the embodiment, the operation-part display area 301 displays the plurality of operation buttons through these steps of the processing.

Moreover in the embodiment, the controller 101 is capable of accepting rearrangement of the operation buttons displayed in the variable area 301a based on the instruction from a user. As the steps for rearrangement, the controller 101 changes ordering of the records in each of the tables (image association table 502a, 502b) of the operation buttons to be displayed in the variable area 301a in accordance with the rearrangement setting accepted from the user, and updates the data of the changed records. Through these steps, the controller 101 executes the processing for rearranging the operation buttons to be displayed in the variable area 301a.

In the embodiment, the controller 101 is capable of accepting assignment of the operation buttons to be displayed in the fixed area 301c from the user. When accepting the assignment, the controller 101 updates the data of the record (the record in “FIX” in FIG. 6) of the operation button to be displayed in the fixed area 301c in all the image association tables 502. Through these steps, the controller 101 executes the processing for assignment of the operation button to be displayed in the fixed area 301c.

<2-2-2. Execution of Function of Operation Button>

Described is the processing for executing the function of the operation button to be displayed in the operation-part display area 301. The controller 101 refers to the coordinate association table 504 and the program table 505 in order to execute the function of the operation button.

The coordinate association table 504 is a group of data set to associate the function to be executed by the operation made on the operation button with the area of the operation button on the touch panel 202. A coordinate field stores the coordinate parameters that specify the areas on the touch panel 202 (display 113) associated with the functions specified by the function IDs, respectively. Based on the coordinate parameter stored in the coordinate field, the area of the operation button is specified on the touch panel 202.

The program table 505 is the data that specifies the program corresponding to the function requested for execution by the operation made on the operation button, and associates the function ID with the program. The program field may store the program itself of the function specified by the function ID, or may store the data to specify the location where the program of the function specified by the function ID is stored.

In the same manner as in the image association table 502, the controller 101 selects, as the processing of the operation screen processor 401, the coordinate association table 504 corresponding to the page to be displayed at the time among the plurality of the coordinate association tables 504 as a target coordinate association table 504c. The relation among a coordinate association table 504a, a coordinate association table 504b and the coordinate association table 504c shown in FIG. 6 is the same as the relation among the image association table 502a, the image association table 502b and the image association table 502c. Thus, the description of the relation is omitted.

When an operation is made on the touch panel 202, the controller 101 judges the function corresponding to the operation button based on the operated position, as the processing of the function judgment processor 403. In particular, when the operation is made on the touch panel 202, the controller 101 specifies the coordinate operated (pushed) on the touch panel 202by referring to the target coordinate association table 504c, and specifies the record storing the coordinate parameter defining the area including the specified coordinate. In accordance with the function ID included in the specified record, the function judgment processor 403 judges the function corresponding to the operation button based on the operated position.

Then, the controller 101 executes the function judged by the function judgment processor 403, as the processing of the function executing part 404. In particular, the controller 101 specifies the function ID identical with the function ID specified by the processing of the function judgment processor 403 by referring to the program table 505. Then, the controller 101 executes the program specified by the data stored in the program field of the specified record.

In the embodiment, through these steps of the processing, when the operation button displayed on the display 113 is operated, the function corresponding to the operated operation button is executed.

Next, the flow of the processing made by the controller 101 is described by use of a flowchart. Hereafter, described respectively are “button operation processing” that is the processing when the operation button is operated, and “button assignment processing” that is the processing for assigning (setting) the operation button in the operation-part display area 301.

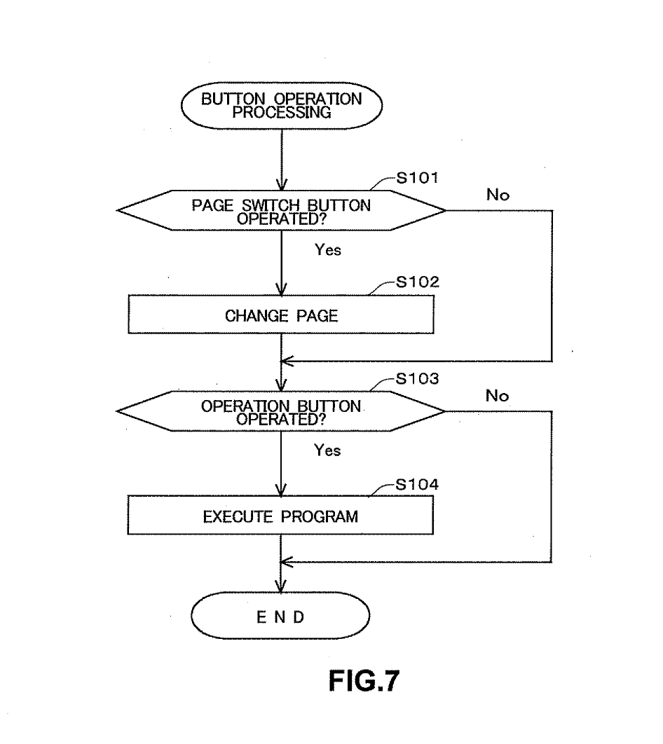

FIG. 7 shows a flowchart of the button operation processing. The processing is repeatedly executed on the working in-vehicle apparatus 1.

At a step S101, the controller 101 judges whether the page switch button has been operated. When the page switch button is operated, the procedure moves to a step S102. When the page switch button has not been operated, the procedure moves to a step S103. At the step S102, the controller 101 changes over the page to be displayed in the variable area 301a. In particular, the controller 101 updates the target coordinate association table 504c shown in FIG. 6 by use of the coordinate association table 504a or the coordinate association table 504b, as well as updating the target image association table 502c by use of the image association table 502a or the image association table 502b.

At the step S103, the controller 101 judges whether the operation button of the variable area 301a or the fixed area 301c has been operated. When one of them is operated, the procedure moves to a step S104. When none of them has been operated, the procedure completes. At the step S104, the controller 101 executes the program corresponding to the operated operation button, and the procedure completes. In an example, the controller 101 searches the function ID corresponding to the coordinate of the operated operation button from the target coordinate association table 504c shown in FIG. 6, and then executes the program that is specified in the program table 505 based on the searched function ID.

Through these steps as above, the controller 101 executes the processing to change over the page to be displayed in the variable area 301a in response to the touch operation made on the page switch button, and the processing to execute the function corresponding to the operation button in response to the touch operation made on the operation button.

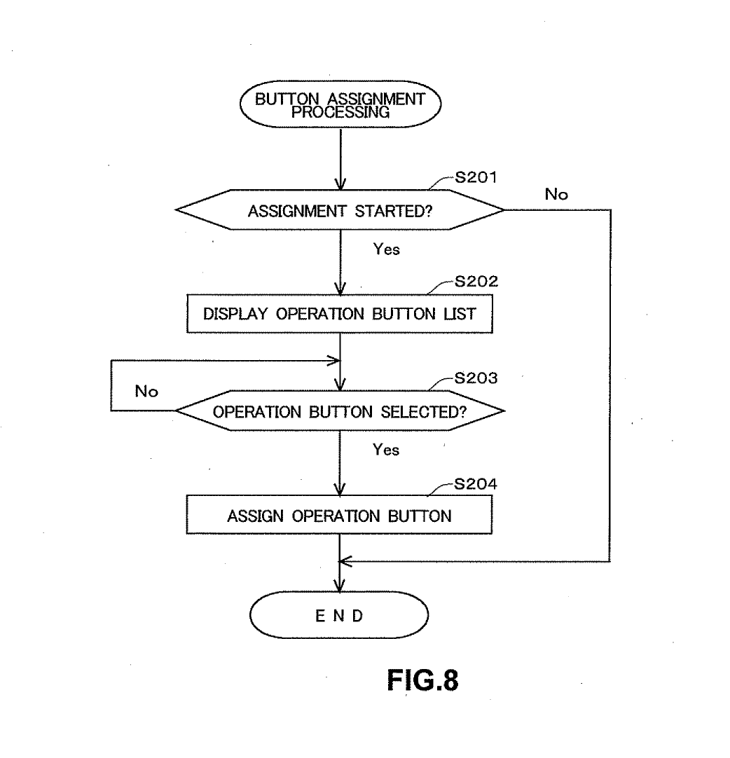

Next, FIG. 8 shows the flowchart of the button assignment processing. The processing is repeatedly executed on the working in-vehicle apparatus 1.

At a step S201, the controller 101 judges whether a predetermined assignment start operation has been executed. When the assignment start operation is executed, the procedure moves to a step S202. When the assignment start operation has not been executed, the procedure completes. In an example, when one of the operation buttons is pushed continuously for longer than a predetermined period of time, the controller 101 judges that the assignment start operation has been executed. Hereafter, taking the position of the operation button pushed continuously by a user as the target position, the processing for assigning another operation button is executed. That is, the user can execute the function of the operation button by operating the operation button for a relatively short period of time, and can also assign another operation button at the position of the operation button by operating the operation button for a relatively long period of time. The user can specify the position targeted for assigning another operation button in either of the variable area 301a and the fixed area 301e.

At the step S202, the controller 101 displays the list of the plurality of operation buttons available for assignment (list of the functions available on the in-vehicle apparatus 1), and the procedure moves to a step S203. Each of the plurality of operation buttons displayed in the list described above is available for assignment in either of the variable area 301a and the fixed area 301c, and is assigned in one of the variable area 301a and the fixed area 301c. At the step S203, the controller 101 judges whether the operation for selecting the operation button to be assigned from the list of the plurality of operation buttons has been executed. When the selection operation is executed, the procedure moves to a step S204. When the selection operation has not been executed, the controller 101 waits for the selection operation made by the user. At the step S204, the controller 101 assigns the selected operation button at the target position. In an example, the controller 101 updates, by use of the data of the selected assignment button, the records corresponding to the target position in the coordinate association table 504a or the coordination association table 504b, and in the image association table 502a or the image association table 502b, shown in FIG. 6.

Through the processing as above, the user can assign the desired operation button for display at the appropriate target position in either of the variable area 301a and the fixed area 301c.

For rearranging the operation buttons, the controller 101 replaces the records, for example, in the coordinate association table 504a or the coordinate association table 504b, and in the image association table 502a or the image association table 502b, shown in FIG. 6, in accordance with the user's operation. Through the processing, the user can dispose the plurality of operation buttons to be included in the variable area 301a or the fixed area 301c in a desired order.

For assigning the operation button in the fixed area 301c, the controller 101 updates the records of the same display position in all of the tables of the coordinate association table 504a and the coordinate association table 504b, and the image association table 502a and the image association table 502b by use of the data of the same selected operation button. Moreover, the user may expand the fixed area 301c, and may add the operation button to be displayed in the expanded fixed area 301c. In this case, the controller 101 updates the records of the same display positions in all of the tables including the coordinate association table 504a and the coordinate association table 504b, and the image association table 502a and the image association table 502b, by use of the data of the same operation button to be added. For reducing the operation buttons displayed in the fixed area 301c, the controller 101 updates the records of the same display positions of the table 504a and the table 504b (table 502a, table 502b) by use of the data of different operation buttons in each of the table 504a and the table 504b (table 502a, table 502b).

It is desirable that the switch operation area 301b be disposed between the variable area 301a and the fixed area 301c. Thus, the data corresponding to the switch operation button are registered in the records corresponding to the positions between the variable area 301a and the fixed area 301c in all of the tables of the coordinate association table 504a and the coordinate association table 504b, and the image association table 502a and the image association table 502b.

As described so far, the in-vehicle apparatus 1 includes the display 113 that has the touch panel function and displays an image, and includes the controller 101 that displays the image including the operation-part display area 301 displaying at least a part of the plurality of operation buttons for receiving the instruction given by the touch operation for executing a prescribed function. The operation-part display area 301 includes the switch operation area 301b, the variable area 301a and the fixed area 301c. The switch operation area 301b displays the page switch button that receives the instruction given by the touch operation for executing the function to change over the contents displayed in the operation-part display area 301. The variable area 301a displays a part of the plurality of operation buttons, as well as changing over the operation buttons to be displayed in response to the touch operation made on the page switch button. The fixed area 301c displays fixedly a part of the rest of the plurality of operation buttons regardless of the touch operation made on the page switch button. Each of the plurality of operation buttons can be displayed in either of the variable area 301a and the fixed area 301c, and assigned to be displayed in one of the variable area 301a and in the fixed area 301c.

That is, on the in-vehicle apparatus 1, the user can assign the plurality of operation buttons to the variable area 301a or the fixed area 301c in accordance with the importance of the respective functions of the plurality of operation buttons. Therefore, the user can set the in-vehicle apparatus 1 that displays continuously the operation button that receives the instruction for executing the more important function by assigning such an operation button in the fixed area 301c.

Moreover, the user can change over the operation buttons displayed in the variable area 301a to the operation buttons that receive the instructions for executing the functions different from the displayed operation buttons. Therefore, while actually keeping the number of the available functions, the in-vehicle apparatus 1 is capable of displaying fewer number of operation buttons on the display 113 at a time.

That is, the in-vehicle apparatus 1 is capable of fixedly displaying the operation buttons that receive the instructions for executing the more important functions, and at the same time, of displaying fewer number of operation buttons on the display 113 while keeping the number of the available functions. This provides the interface superior in operability.

<3. Others>

Although the embodiment of the invention has been described so far, the description above is just the example of the invention in all respects. The invention is not limited by the description. It is therefore understood that numerous other modifications and variations can be devised without departing from the scope of the invention.

In an example, the operation buttons displayed in the variable area 301a and the fixed area 301c in the above embodiment are the source selector buttons that receive instructions for selecting audio sources. However, the operation buttons displayed in the variable area 301a and the fixed area 301c in the embodiment are not limited to the operation buttons having such functions. The functions of the operation buttons displayed in the variable area 301a and the fixed area 301c may be appropriately changed.

The technology in the embodiment can also be executed by an information processing method, a program, a non-transitory computer-readable memory medium storing a program, or others. The non-transitory computer-readable memory medium is the medium that stores information such as a program electrically, magnetically, optically, mechanically or chemically.

While the invention has been shown and described in detail, the foregoing description is in all aspects illustrative and not restrictive. It is therefore understood that numerous other modifications and variations can be devised without departing from the scope of the invention.

What is claimed is:

1. An information processor comprising:
a display that includes a touch panel and that displays an image; and
a controller that displays on the display the image that includes an operation-part display area displaying at least a part of a plurality of operation parts that receive instructions for executing prescribed functions, the instructions given by a touch operation of the operation parts by a user, wherein
the operation-part display area includes:
a first area that displays a switch operation part that receives an instruction for executing a function to change over contents displayed in the operation-part display area, the instruction given by a touch operation of the switch operation part by the user;
a second area that displays a part of the plurality of operation parts and that changes over the part of the plurality of operation parts to be displayed in the second area in response to the touch operation made by the user on the switch operation part; and
a third area that displays a part of a rest of the plurality of operation parts fixedly regardless of the touch operation made by the user on the switch operation part, wherein
each of the plurality of operation parts is able to be selected for display in either of the second and third areas, and assigned to be displayed in one of the second and third areas.

2. The information processor of claim 1, wherein
the controller displays the first area between the second area and the third area.

3. The information processor of claim 2, wherein
the controller displays the first area, the second area and the third area in a line.

4. The information processor of claim 3, wherein
the controller displays the first area, the second area and the third area in a vertical line.

5. The information processor of claim 4, wherein
the information processor is installed in a vehicle, and
the controller displays the first area, the second area and the third area at a side edge of the display, the side edge being closer to a driver seat of the vehicle.

6. The information processor of claim 1, wherein
the controller accepts, from the user, assignment of one or more of the operation parts to be displayed in the third area.

7. The information processor of claim 1, wherein
the controller accepts, from the user, rearrangement of the operation parts to be displayed in the second area.
